(19) United States
(12) Patent Application Publication
(10) Pub. No.: US 2024/0098618 A1
(43) Pub. Date: Mar. 21, 2024

(54) NETWORK COMMUNICATION APPARATUS AND SYSTEM

(71) Applicant: Reskube Ltd, East Sussex (GB)

(72) Inventor: Andrew James LAWTON, East Sussex (GB)

(21) Appl. No.: 18/551,751

(22) PCT Filed: Mar. 24, 2022
(86) PCT No.: PCT/GB2022/050742

§ 371 Date: Sep. 21, 2023

(30) Foreign Application Priority Data
Mar. 24, 2021 (GB) 2104166.0

(51) Int. Cl. H04W 40/12; H04L 45/00

(52) U.S. Cl. CPC H04W 40/12; H04L 45/22

(57) ABSTRACT

A network communication apparatus comprising a router that routes an internet signal, a controller that controls the router the router including a mobile internet connection and a fixed line internet connection, the controller capable of monitoring the internet connection and switching between the mobile internet connection and a fixed line internet connection depending on the speed and/or reliability of each internet connection.

The present specification relates to a network communication apparatus and system, particularly for home and remote workers.

It is increasingly common for people within an organisation to work from home or from some location physically removed from that organisation. Typically, they will connect to the internet using their home network and home broadband router. However, such workers are vulnerable to security breaches, and disconnection due to power supply failure or network failure. In order to set up secure and resilient systems, the home worker must either be technically competent to set up the necessary apparatus, or a technically skilled person must visit the location to do this for them.

The object of the present invention is to allow home workers and/or other remote workers that undertake time critical activities to increase their security and resilience. The aim is to reduce the potential financial or other impact to them, their customers, their employers or other stakeholders.

According to the present invention, there is provided a network communication apparatus according to one or more of the independent claims.

The invention will now be described, by way of example, with reference to the drawings, of which

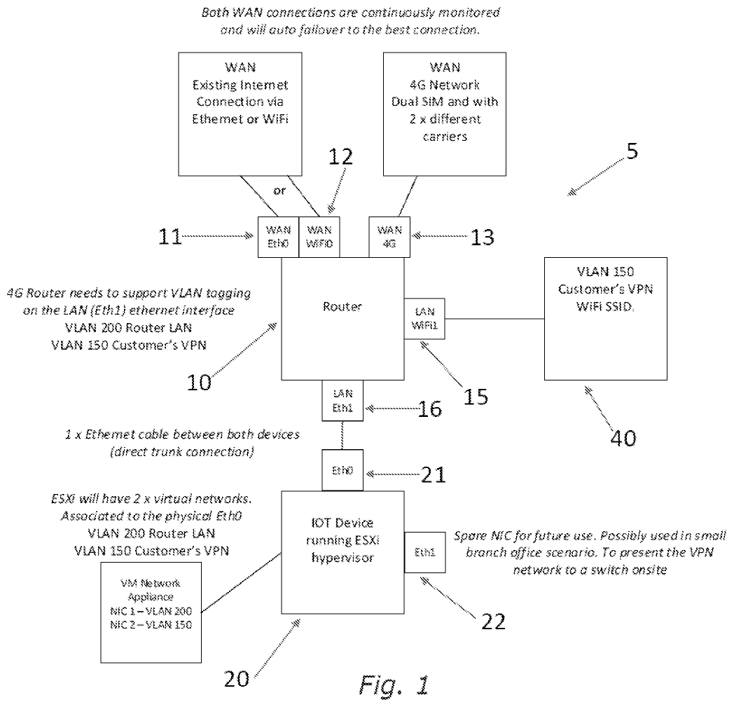

FIG. 1 is a diagrammatic view of a network communication apparatus according to an embodiment of the invention, and

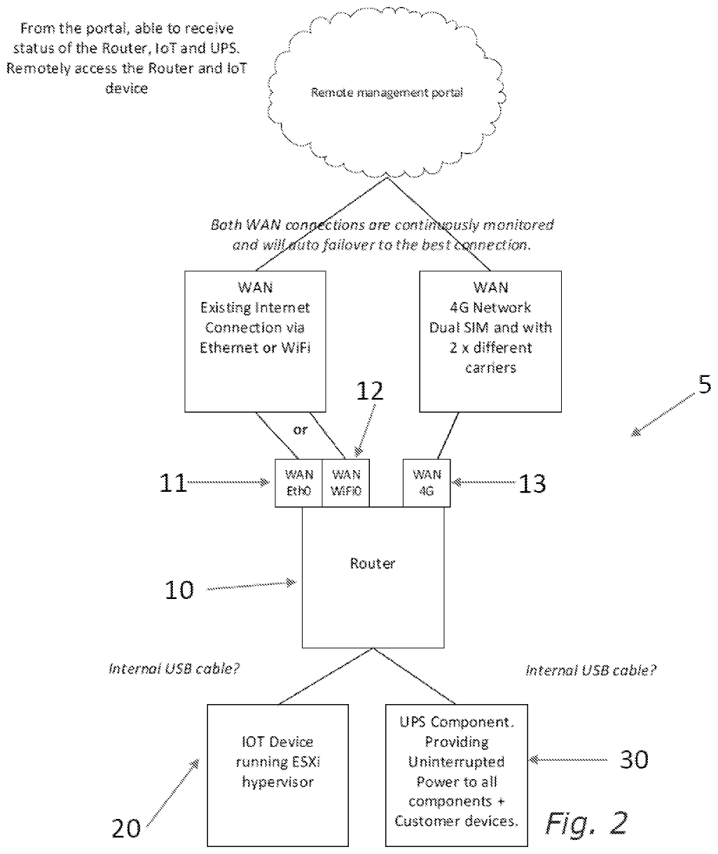

FIG. 2 is a diagrammatic view of the network communication apparatus showing further detail.

The network communication apparatus disclosed herein allows an organisation to set up the network connections for a user, without the user having to configure a router.

Referring to FIG. 1, a network communication apparatus 5 comprises a router 10, a controller, which is preferably an IOT (Internet of Things) device 20, and referring also to FIG. 2, a UPS (Uninterruptible Power Supply) 30. The network communication apparatus ideally includes these components within a single housing or enclosure. The router includes a number of network interfaces, includes an Ethernet WAN (Wide Area Network) network interface 11, a WiFi WAN network interface 12, and a 4G network interface 13, the router 10 having one or two inbuilt 4G SIMs. The router 10 also includes a WiFi LAN network interface 15.

The IOT device 20 provides a platform to run enterprise security or network management agents to assist the organisation's central security and network management teams, or managed services providers, to remotely manage the device and also link it securely into the corporate network, via a VPN socket for example. The controller's functionality could alternatively be provided by a ESXi hypervisor, or something else that provides a computing platform on which the enterprise or managed services provider can add a socket or VPN Agent which will link the device back into the secure cloud.

The router 10 broadcasts the user's VLAN (Virtual Local Area Network) 40 here shown as VLAN 150, and includes the user's Customer's VPN (Virtual Private Network) WiFi SSID (Service Set Identifier).

The IOT device 20 may be connected to the router 10 through an ethernet interface 21 on the IOT device 20 and an ethernet LAN network interface 16 on the router 10. The IOT device 20 provides a platform for the secure socket, and may be running a hypervisor such as ESXi hypervisor, with the ethernet LAN network interface 16 split into two VLAN, one for the IOT device 20 itself, and one for the user's VLAN 40.

The 2 VLANs could be the router 10 LAN (shown as VLAN 200) and Customer's VPN (shown as VLAN 150). The router LAN VLAN (200) originates from the router device (10). The Customer's VPN VLAN (150) originates from the Virtual appliance which would be running on the IOT device (20).

Both the router 10 and the IOT device 20 may have limited physical network ports. The use of VLAN allows the IOT device 20 and the user's VLAN 40 to use a direct trunk connection via a single Ethernet LAN so that the router LAN (VLAN 200) and Customer's VPN (VLAN 150) are kept separate. The IOT device 20 and the user's devices will be on different IP subnets and both have their own DHCP server (which would cause conflicts if both on the same network). One VLAN would provide the Internet feed created from the Router (which is protected by the auto failover system) and the other VLAN would provide the VPN/secured corporate network created by the virtual appliance that runs on the small computer platform/mini hypervisor of the IOT device 20.

The router 10 will broadcast either the IOT LAN (shown as VLAN 200) or Customer's VPN (shown as VLAN 150) SSID WiFi networks. The Customer's VPN (VLAN 150) is created by the IoT device/small open computing platform. The user then connects their devices to either IOT LAN or Customer's VPN SSIDs which would be protected by the router 10 (which would auto failover to whichever WAN interface is the most stable).

The user's computing devices such as a desktop computer, laptop computer, tablet, smart phone and/or other devices, can thus access the internet via the router using one of the network interfaces 11, 12, 13, in the case of the Ethernet WAN network interface 11 or WiFi WAN network interface 12 to the Internet via a cable or DSL connection for example, or in the case of the 4G WAN network interface 13 via a 4G broadband cellular connection in the case of the 4G WAN network interface 13. The router 10 continuously monitors the internet connection, and automatically selects the best connection, that is the one with the highest or data transfer speed or the one giving the most reliable data transfer. In the event of a loss of connection with either internet connection, the router failovers to the other Internet connection. In a situation in which there is no WAN/Internet directly available, and the primary internet is via one of the 4G inputs, such as a construction site, or vaccination site where there is no wired internet available, the failover would then be to the second 4G input if this has been provided.

The user's secure VPN (shown as VLAN 150) is created by the IOT device 20, however some other user's network such as a Next Generation Firewall, could alternatively be created. The organisation's IT network or security teams would have remote access to the IoT device to effect setup and maintenance. The overall management of the hardware of the network communication apparatus 5 which contains all router, IOT and UPS device would be via a cloud management platform.

The IOT device 20 may include a spare NIC 22 (Network Interface Controller) to present the VPN network to a switch onsite, allowing the network communication apparatus to be used in small branch office scenario. The NIC 22 allows the network communication apparatus 5 to switch and share the Customer's VPN VLAN (150) to other devices in a small branch office.

The UPS 40 ensures that power will be continuously delivered to critical systems of the apparatus from the device's onboard batteries in the event of a mains power failure. The network communication apparatus 5 also includes power sockets for the user's computing devices, particularly for example if the user is using a desktop computer which does not include a battery, so that the user can continue to work in the event of a mains power failure.

The network communication apparatus thus provides a level of resilience and security that would normally be associated with the corporate office.

Maintenance and updates to the router 10 may be carried out remotely via the IOT device 20. Thus, while the infrastructure is located close to the network communication apparatus user, many network communication apparatus services or many end users who are geographically distributed may be conveniently managed by an organisation using the WAN network connections. Each network communication apparatus can be simply connected to an internet cable (if present) and/or scan for an available 4G signal, a power supply, and then the network communication apparatus establishes contact with the organisation's control servers to exchange control and monitoring data. Then, configuration of the router and the user's VLAN can be carried out by the organisation remotely via the IOT device 20. A central security and network management team of an organisation is thus able to make contact with update, secure and report on all of the distributed network communication apparatuses, for example through a single control dashboard, ideally provided by a cloud management platform.

If the user doesn't require the IoT device, it could be unpatched and the network communication apparatus connected to a PC, Laptop of switch which accessed the router LAN (shown as VLAN 200); in such a case, VLAN tagging on the port would be removed. This could be done via the cloud management platform remotely.

The network communication apparatus 5 can be remotely managed via the 4G WAN connection ‘out of the box’ from the Cloud management platform. The Cloud management platform can configure the router remotely and connect the WAN WiFi connection to the user's home WiFi SSID.

The example described herein shows the router and IOT device be connected with a single Ethernet LAN interface. Alternatively, another Ethernet LAN interface could be added to the router 10 to accept another LAN; in this case, VLANs may not be required.

Examples of applications which may utilise the network communication apparatus are augmented reality for remote repair and telemedicine, IoT devices for capturing utility (water, gas, electric, facilities management) data, inventory, supply chain and transportation solutions, smart cities, smart roads and remote security applications, which all rely on the data networks to greater or lesser degrees. These applications all benefit from edge computing's ability to move workloads closer to the end user and IOT device.

The network communication apparatus provides a pre-packaged solution which can be simpler and more convenient for a user to set up, to deliver compute and storage combined with resilient power and communications for the users of the network communication apparatus 5, or connected IOT Devices and the organisations that rely on them.

The network communication apparatus is described here as using the 4G broadband cellular network standard; it will be realised that 5G or other communication standards could be equally be utilised.

In addition to the aspects delineated in the claims, further important aspects of the present invention include
A1. A network communication apparatus comprising
   a router that routes an internet signal
   a controller that controls the router, and
   a ups.
A2. A network communication apparatus according to feature A1 wherein the router including a mobile internet connection and a fixed line internet connection, the controller capable of monitoring the internet connection and switching between the mobile internet connection and a fixed line internet connection depending on the speed and/or reliability of each internet connection.
A3. A network communication apparatus according to either feature A1 or A2 wherein the controller being capable of actuating the router to establish an internet connection remotely, and establishing a connection over the internet to an organisation's control server.
A4. A network communication apparatus comprising
   a router that routes an internet signal
   a controller that controls the router
the controller being capable of actuating the router to establish an internet connection remotely, and establishing a connection over the internet to an organisation's control server.
A5. A network communication apparatus according to feature A4 wherein the router including a mobile internet connection and a fixed line internet connection, the controller capable of monitoring the internet connection and switching between the mobile internet connection and a fixed line internet connection depending on the speed and/or reliability of each internet connection.
A6. A network communication apparatus according to either feature A5 or A6 wherein the network communication apparatus includes a UPS.
A7. A network communication apparatus according to any previous feature wherein the router including an ethernet WAN network interface and a Wifi WAN network interface.
A8. A network communication apparatus according to any previous feature wherein the router including a 4G WAN network interface.
A9. A network communication apparatus according to any previous feature wherein the router supports a VLAN network.

In this specification an apparatus/method/product “comprising” certain features is intended to be interpreted as meaning that it includes those features, but that it does not exclude the presence of other features.

Many variations are possible without departing from the scope of the present invention as defined in the appended claims.

1. A network communication apparatus comprising:
a router that routes an internet signal; and
a controller that controls the router;
the router including a mobile internet connection and a fixed line internet connection, the controller capable of monitoring the internet connection and switching between the mobile internet connection and a fixed line internet connection depending on the speed and/or reliability of each internet connection.

2. A network communication apparatus according to claim 1 wherein the network communication apparatus includes a UPS.

3. A network communication apparatus according to claim 1 wherein the controller being capable of actuating the router to establish an internet connection remotely, and establishing a connection over the internet to an organisation's control server.

4. A network communication apparatus according to claim 3, wherein the router including an ethernet WAN network interface and a Wifi WAN network interface.

5. A network communication apparatus according to claim 4, wherein the router including a 4G WAN network interface.

6. A network communication apparatus according to claim 5, wherein the router supports a VLAN network.
